(19) United States
(12) Patent Application Publication
(10) Pub. No.: US 2012/0061338 A1
(43) Pub. Date: Mar. 15, 2012

(54) Method of configuring rack storage and a rack assembly so configured

(76) Inventors: Todd Willick, Mississauga (CA); Richard Panetta, Milton (CA); Wes van Ooyen, Burlington (CA); Derek Bessette, Milton (CA)

(21) Appl. No.: 12/881,817

(22) Filed: Sep. 14, 2010

(51) Int. Cl. A47F 1/04; B23P 19/00

(52) U.S. Cl. 211/59.2; 29/428

(57) ABSTRACT

A method of configuring storage in a dispensing kiosk and an assembly of rack modules forming a rack, the assembly selected using the configuration method. The selection uses one or more rack modules from a set of rack modules, each having an array of bins having a range of bin sizes and a range of quantities of bins of each size, so as to present a predetermined bin size distribution. The bin size distribution of one rack module of the set differs from the bin size distribution of the other rack modules of the set so that different combinations of members of the set can be assembled to maximize efficiency of stocking of items in the rack. A target inventory of items for stocking the dispensing kiosk is picked, the inventory having a range of item sizes and a range of quantities of each item size. Combinations of the rack modules are then investigated as candidates for mounting to form the rack, and the rack module combination is selected that, according to stocking rules, will maximize efficiency of stocking of the target inventory in the rack.

### FIELD OF THE INVENTION

This invention relates to a method of configuring storage in a dispensing kiosk and has particular application to a rack arrangement for a medicament dispensing kiosk. The invention also extends to a rack assembly formed using the method of the invention.

### DESCRIPTION OF RELATED ART

The traditional means of dispensing prescribed medicaments involves a doctor meeting with a patient and prescribing a medicament based on a particular diagnosis, and then hand writing and signing a prescription for the patient to carry to a pharmacist at a pharmacy location for fulfillment. In recent years, two major advances have occurred in the field of medicament dispensing. The first is the advent of electronic prescription capturing methods, systems and apparatus, which improve the overall accuracy and patient record-keeping associated with prescribing drugs. The second is the advent of automated apparatus, typically configured as kiosks, from which medicaments can be automatically dispensed, the kiosks being located for convenient patient access, such as at a doctor's premises, a hospital or mall, and being networked with a system server for inventory control and management. In this regard, reference may be made to applicant's copending PCT application serial no. PCT/CA2007/001220 related to a method, system and apparatus for dispensing drugs.

More specifically, the PCT application describes a networked system having a server, a database of patient information linked to the server, a first client having input means linked to the server and operable to generate a script for a medicament prescribed to a user, a second client comprising an automated apparatus for dispensing medicaments (referred to in said PCT application as a robotic prescription dispensary) operable to recognize a human and/or machine readable description in the script, and to provide validating cross-referencing between the description and patient information as a prelude to dispensing a drug to the user on the basis of the input script. A doctor in a clinic can be a third client having input means linked to the server to input appropriate prescription information, or accept certain prescription information from the database as being applicable in the particular case for a particular patient. Further, the doctor's client device can be operable to display patient information, e.g., drug history, insurance coverage, etc., and a printer module can print the script as a paper print-out.

The server and database enable storing, compiling and retrieval of patient data including name, address, and diagnostic and drug history. Access to the database can be provided to both the doctor and the automated apparatus for dispensing medicaments via the server, via a secure connection, or via a link between the system and a clinic's existing clinic management system or patient database.

The described apparatus also includes a user interface, a teleconferencing or video-conferencing means enabling communication between the user and a human validation agent, and a scanning means for capturing an image of the script so that it, if needed, it can be viewed by a human validation agent, such as a licensed pharmacist communicating in the system and with the apparatus from a remote location to the apparatus, to approve a prescription. The user interface of the dispensary apparatus provides detailed and clear instructions to guide the user.

An authentication means confirms the identity of the patient, for example, by prompting for a personal identification number or by biometric means or by associating certain questions to answers provided by the patient that identify the patient to the apparatus, and cross-referencing this information with the patient information stored on the networked database. Once the patient is recognized, the dispensary apparatus prompts the user for a script and the apparatus processes the user-input script either by the above-mentioned human validation agent or by processing the machine readable description (which may be a bar code). This information can be verified with the server and the database. The apparatus may also interface with the server to adjudicate insurance claims and to determine amounts payable by patients. The patient either accepts or rejects the transaction. If the transaction is accepted, the apparatus interfaces with the server to transact a payment, for example, by prompting the patient for credit card information. Prescription labels and receipts are printed. The apparatus confirms that the drug is correct and delivers it to a dispensing area for retrieval by the user while retaining the script in a lock box, and verifying that the purchased drug product has been retrieved. Further, the apparatus may print and/or provide to the user educational materials relevant to the medicaments that have been dispensed. The automated dispensing apparatus for is of significant value in enabling a patient to obtain prescribed medicaments without having to attend a pharmacy or drug store.

In known medicament dispensary kiosks for dispensing bottles or packages of drugs or other medicament items, the items are typically stocked in a row column rack of bins. Medicament items may have a range of shapes and sizes depending on the size of the medicament to be dispensed and on the particular packaging practices of the medicament supplier. Because space is at a premium in such a kiosk, ideally a bin size for a particular medicament item closely matches the size of item. Because the distribution of item sizes will normally vary from kiosk to kiosk, the bin racks would ideally be tailored for the particular kiosks in which they are to be installed. However, setting up a kiosk to match bin sizes closely to item sizes for a range of sizes can take an inordinate amount of time.

### SUMMARY OF THE INVENTION

According to one aspect of the invention, there is provided a method of configuring storage in a dispensing kiosk using one or more rack modules of at least some of a set of rack modules, the rack modules each having an array of bins having a range of bin sizes and a range of quantities of bins of each size thereby to present a predetermined bin size distribution, the predetermined bin size distribution of one rack module of the set differing from the predetermined bin size distribution of the other rack modules of the set, the rack modules adapted to be mounted on a kiosk support structure to form a rack, the method comprising taking a target inventory of items for stocking the dispensing kiosk with items, the items of the target inventory having a range of item sizes and a range of quantities of each item size, determining a plurality of combinations of the rack modules as candidates for mounting on the kiosk support structure to form the rack, selecting that combination of the rack modules from a plurality of combinations of the set of rack modules that will maximize efficiency of stocking of the target inventory in the rack if the stocking is effected pursuant to at least one stocking rule, and mounting the selected combination of rack modules on the kiosk support structure.

The bin size and the item size can be either or both of height and width. Preferably, the array of bins is a row-column array, and the rack module has vertical walls extending over the full vertical extent of the rack module and horizontal walls extending over the full horizontal extent of the rack module. The rack modules are preferably easily mountable and demountable in the dispensary kiosk, as by brackets depending from a back wall of the rack modules being engageable with anchor means such as slots in a back wall of the kiosk.

An exemplary stocking rule comprises each of the items of a certain size being stockable in only one size of bin, while an alternative stocking rule comprises each of the items of a certain size or range of sizes being stockable in any of a multiple of sizes of bin. A further stocking rule may govern the size of items that can be placed in a particular size of bin by requiring that for any such placed item, there is a excess of bin size over item size that is greater than a predetermined threshold or that is between predetermined limits. A bin may accommodate a single item or a row or stack of items. Depending on the size of the particular items, the row or stack may have a relatively large or small depth. A further exemplary stocking rule determines that items of a row or stack should take account of item depth and should fill each bin.

The stocking efficiency of a rack module combination may be measured against a number of factors indicative of stocking efficiency. Most important is the efficient use of vault storage volume. In one exemplary metric, the efficiency is measured on the basis of the cumulative excess of bin size over item size for all of the bins of the rack when populated with the target inventory, with such cumulative excess being any one or more of width, height, and depth. Another exemplary metric is the maximum number of items of a target inventory that can be accommodated in the rack module combinations (if less than the target inventory can be accommodated) or the maximum number of items over the target inventory that can be accommodated (if more than the target inventory can be accommodated). Any of a number of secondary factors can be factored into the measurement metric such as stocking flexibility and inventory fragmentation.

The stocking efficiencies can be determined by notionally fully stocking the target inventory in the respective rack module combinations, comparing the determined efficiencies, and selecting the combination with the highest efficiency. Alternatively, or in addition, an interim efficiency is predicted at an interim stage in the notional stocking of a rack module combination and the combination is discarded if can be projected that the stocking efficiency of the combination when fully stocked is likely to be below an acceptable threshold. In a further alternative, an initial projection of stocking efficiency is made, for example, by counting from the target inventory the total number of items in one or more size categories, for example, the total number of small items, and then analyzing only those available combinations of rack modules having a number of small bins sufficient to accommodate all of the small items.

According to another aspect of the invention, there is provided an assembly of rack modules mounted in a kiosk support structure to form a rack, the assembly of rack modules comprising one or more rack modules of at least some of a set of rack modules, the rack modules of the set each having an array of bins having a range of bin sizes and a range of quantities of bins of each size thereby to present a predetermined bin size distribution, the predetermined bin size distribution of one rack module of the set differing from the predetermined bin size distribution of the other rack modules of the set, the assembly selected in relation to a target inventory of items for stocking the kiosk with items, the items of the target inventory having a range of item sizes and a range of quantities of each item size, the selection made from a plurality of combinations of the rack modules determined to be candidates for mounting on the kiosk support structure to form the rack, the selection being that combination of the rack modules that maximizes efficiency of stocking of the target inventory in the rack if the stocking is effected pursuant to at least one stocking rule.

Preferably in such an assembly, the bin size and the item size comprise one or both of height and width and the bin arrays are row-column arrays with each rack module having vertical walls extending over the full vertical extent of the rack module and horizontal walls extending over the full horizontal extent of the rack module.

In such an assembly, the rack module combination has been selected based on the at least one stocking rule being that items of a certain size are stockable in only one size of bin. Alternatively the rack module combination has been selected based on the at least one stocking rule being that items of a certain size are stockable in up to two sizes of bin. The assembly is preferably assembled subject to the at least one stocking rule requiring that the stocking of each item into a corresponding bin leaves a predetermined excess of the bin size over the item size.

In such an assembly, the rack modules can be mounted to a back wall of the kiosk such as by means of brackets on the modules engaging slots in a back wall of the kiosk.

In such an assembly, the stocking efficiencies can have been determined by notionally fully stocking the target inventory in the respective rack module combinations, comparing the determined efficiencies, and selecting the combination with the highest efficiency. Alternatively, in such an assembly, an interim efficiency of the of a candidate rack module combination can have been determined at an interim stage in the notional stocking based on a candidate rack module combination with such candidate rack module combination having been discarded from candidacy if the interim efficiency was below a threshold.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a front view of a front end door unit for a dispensing kiosk according to one embodiment of the invention.

FIG. 2 is a schematic top view of a dispensing kiosk according to an embodiment of the invention.

FIG. 3 is a front view of a drug vault of a dispensing kiosk according to another embodiment of the invention with front end units removed.

FIG. 4 shows a front view of a first form of rack module for use in a rack assembly according to one embodiment of the invention.

FIG. 5 shows a front view of a second form of rack module for use in the rack assembly.

FIG. 6 shows a front view of a third form of rack module for use in the rack assembly.

FIG. 7 shows a front view of a rack loading module for use in the rack assembly.

FIG. 8 is a perspective view of a rack module for use in an embodiment of the invention.

FIG. 9 is a top view of a rack module for use in an embodiment of the invention.

### DETAILED DESCRIPTION OF THE INVENTION INCLUDING THE PRESENTLY PREFERRED EMBODIMENTS

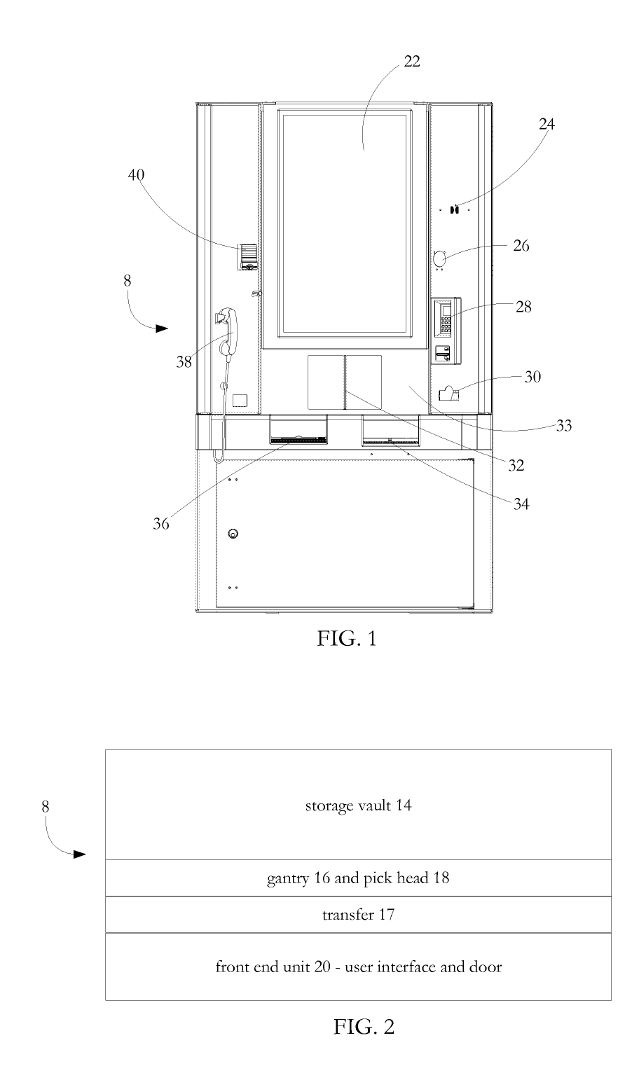

Referring in detail to FIG. 1, there is shown a dispensary kiosk 8 having front end unit 20. The front end unit 20 functions as a user interface which can be accessed by a user for presenting a script, for communicating with a remote pharmacist and for obtaining drugs or other medicaments as detailed on the script. The front end unit 20 also functions as a door to enable access to the interior of the kiosk for servicing. The kiosk is shown in schematic top view in FIG. 2.

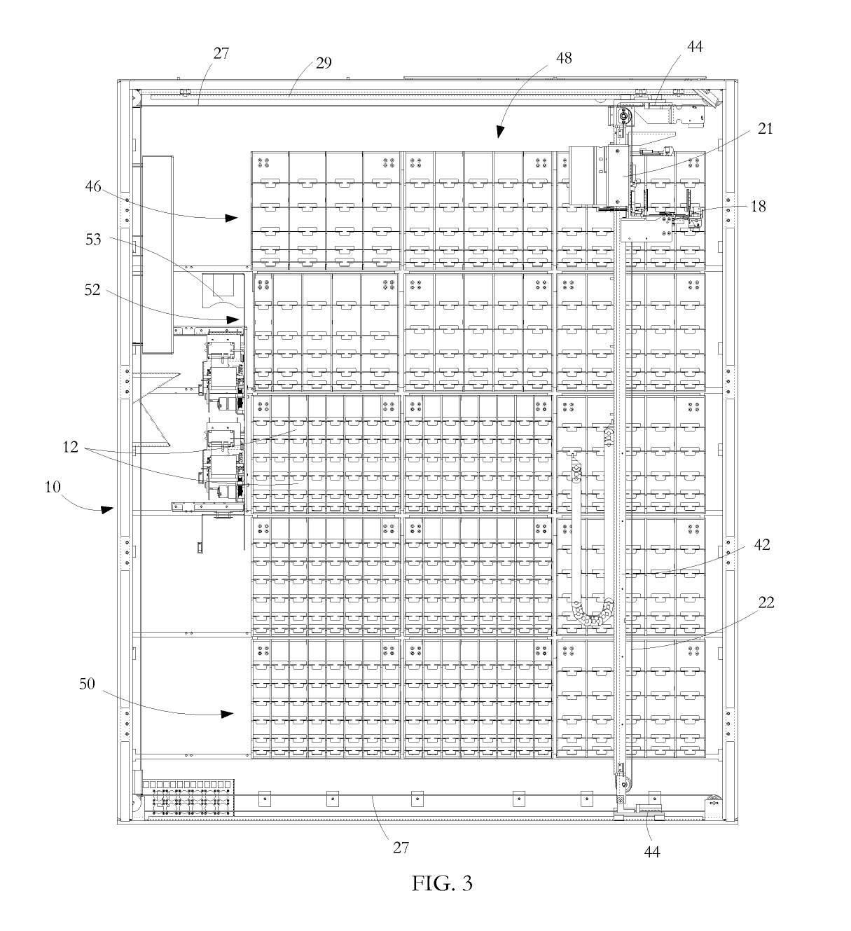

The kiosk includes a secure back end medicament storage vault 14 which is shown in front view in FIG. 3 with the front end unit removed. The storage vault has a rack of storage bins 12 arranged in a row and column array. The bins vary in shape and size to accommodate different sizes of items to be dispensed. The vault includes a gantry 16 and pick head 18 for picking medicament items from the vault bins 12 and a transfer unit 17 for passing items forwardly from the pick head to the front end unit 20, the transfer unit having an associated weigh module (not shown) for measuring items as they are transferred to the front end unit. The front end unit bars unauthorized access to the drug vault 14 but can be opened to expose the drug vault for servicing. Mounted in the front end unit, the user interface enables a user to enter data, communicate with a remote expertise or data records through a data or teleconference link, and collect dispensed items. As shown in FIG. 1, the user interface includes a touch screen 22, a hailing speaker 24, a camera 26, a digital payment module 28, a card reader 30, a dispense door 32 which opens to provide user access to a dispensing bay 33, a scanner 34, a printer 36, a telephone 38, and a coin payment module 40.

As shown in the front view of FIG. 3, where the kiosk is shown with the front end door unit removed, the pick head 18 is mounted for movement on the gantry. The gantry includes a vertically reciprocable carriage 21 which is driven by a belt drive 42 along a vertical guide rail 23. The rail 23 is mounted between two linked, horizontally reciprocable carriages 44. The carriages 44 are driven by belt drives 27 along horizontal rails 29. The carriages 21 and 44 are movable in a plane which extends parallel to a front access side of the bin rack. In this way, the pick head 18 can be placed adjacent any selected one of the bins 12 at the front access side. The pick head 18 is used to pick a chosen item from its position in the rack of bins and, if part of a front-to-back row of items 55, as more clearly shown by the top view of FIG. 9, from its position within the row, in preparation for dispensing the item at the dispensing bay 33. To pick an item from a bin, the pick head is driven on the gantry in X and Y directions to a desired XY position corresponding to the selected bin. A platform forming part of the pick head is then moved in the Z direction to pick the item from the selected bin. Optionally, the pick head 18 is also used to load medicament items into a bin in a reverse process. Particular pick head mechanisms suitable for use with the illustrated rack of the present invention are described in applicant's co-pending U.S. patent application serial no. 12/503,989.

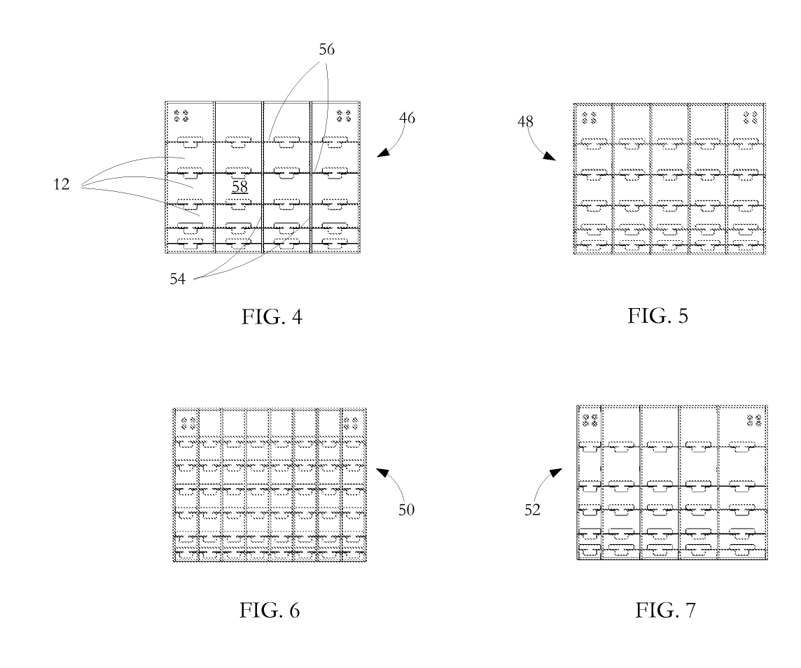

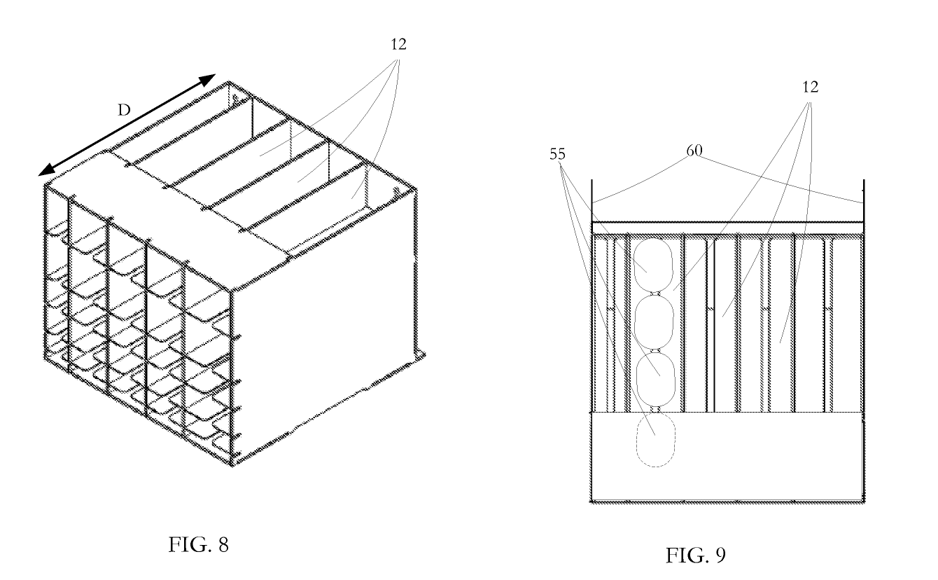

As shown in FIG. 3, the rack has a series of rack modules 46, 48, 50, 52. Modules 46 are for storing large items, and one such module is shown in FIG. 4. Modules 48 are for storing medium sized items, and one such module is shown in FIG. 5. Modules 50 are for storing small items, and one such module is shown in FIG. 6. Depending on a range of sizes of products to be stocked in the rack, a particular combination of the rack modules 46, 48, 50 is assembled to form the rack as shown by the exemplary configuration of FIG. 3. Module 52 is a loading module and is shown in greater detail in FIG. 7.

Referring particularly to FIG. 4, the rack module 46 is rectangular in form and has a lattice of vertical walls 54 and horizontal walls 56 which together define a row column array of bins 12. The walls may be formed as a single moulding or constructed from separate sheets which are disposed and locked together to form the lattice array illustrated. A back wall 58 is made integral with the lattice of horizontal and vertical walls and is formed with brackets 60 as shown in the top view of FIG. 9. The brackets cooperate with slots (not shown) formed in a back wall of the storage vault 14 to permit the rack module 46 to be demountably mounted on the back wall. To remove a rack module, it is lifted upwardly into vertical spacing left between vertically adjacent modules so as to disconnect the brackets from their engaging slots in the back wall. The module is then withdrawn forwardly from the rack assembly. The replacement module is then installed in the vacated bay in a reverse procedure. Clearly, other forms of fixture for mounting the rack modules to the vault back wall can be used such as any suitable screw, clamp or clip arrangement.

The bins 12 of the rack modules 46 have a common width of 105 mm. The rack module has five rows of bins, with bins in the bottom row having a height of 35 mm., bins in the next upwardly adjacent row having a height of 52.5 mm., bins in the next two intermediate rows having a height of 70 mm., and bins in the top row having a height of 87.5 mm. The rack module 48 of FIG. 5 has a common width of 82.5 mm. and five rows of bins having the same height distribution as the module 46. The rack module 50 shown in FIG. 6 has a common width of 50 mm. The two bottom rows of bins each have a height of 35 mm., four intermediate rows each have a height of 52.5 mm., and a top row has a height of 70 mm.

As shown in FIG. 7, bins of the loading module 52 extend over the whole range of bin sizes to facilitate kiosk loading and generally match the size mixes of a typical target inventory, albeit with far fewer bins than are required for the full target inventory. When the vault is first stocked, or subsequently restocked, new stock to be assigned to the dispensary kiosk is loaded into the bins of the loading module so as generally to match item to bin size. Subsequently, the items are transferred from the bins of the loading module into targeted bins of the storage modules. The loading procedure is typically performed at a quiet time, either when dispensing demand can be predicted to be low or when, by automated monitoring, it is determined that no dispensing or other inventory management operation is in progress. The rack loading module 52 is designed to encompass the whole range of item sizes that exist throughout the set of rack storage modules 46, 48 and 50. The size distribution is chosen generally to match the expected size distribution of a random list of items to be stocked in the rack. Once again, it is emphasized that, when referring herein to item and bin “size”, this may mean one or more of width, height and depth, When transferring an item of new stock from the loading bin to a designated storage bin, a serializing process is carried out to serialize each of the items to be loaded. An item to be serialized is selected and drive to the pick head 18 is actuated to move the pick head to a suitable one of the bins of the rack loading module 52 and to pick up the selected item located at that bin. The selected item is brought by the pick head to an inspection station 53 and inserted by the pick head 18 to a reference position where serialization data is accumulated and recorded and where a serializing tag may be applied to the item. The pick head is then driven to take the item from the reference position to a selected one of the storage bins and stored serialization data is updated to show the new item location.

As shown by the views of FIGS. 8 and 9, the storage bins 12 have a common depth D to allow stacking of several medical items 55 in a depth-wise row. Although the bins in each of the rack storage modules 46, 48 and 50 have a common bin width characterizing the particular module, in another embodiment of the invention (not shown) both the heights and the widths of each bin in the row column array of a rack module may vary in comparison with at least one of the other bins in the module. In a further embodiment of the invention, the width, but not the height, varies among the bins of a particular rack module.

Referring back to FIG. 3, fifteen rack modules are shown assembled in a 5×3 array, the modules mounted to the back wall of the kiosk cabinet as previously indicated. The array has one large item bin module 46 at row (R) 1, column (C) 1, a loading module 52 at R2, C1, seven medium item rack modules 48 at each of R1,C2, at R1,C3, at R2, C2, at R3, C3, at R4, C3 and R5, C3, and six small item rack modules at each of R3, C1, at R3, C2, at R4, C1, at R4, C2, at R5, C1 and R5, C2. The particular configuration of the three types of storage racks, and therefore the distribution of storage bin sizes in the rack as a whole, is chosen generally to match the distribution of sizes that exist in a target inventory or medication list for that kiosk. Other combinations of rack modules 46, 48 and 50 can be adopted to accommodate more closely a distribution of sizes that might exist in a different projected medication list or inventory. Such variations might exist for example owing to a different age demographic as between kiosks located in different communities or owing to the demands on dispensary kiosks located at speciality clinics.

In selecting a rack module combination, it is desirable to match the distribution of bin sizes that will be available in the rack to what is projected to be the distribution of item sizes for the medication list to be stocked in that kiosk. If stocking occurs without regard to size matching, then available storage space in the cabinet will be wasted. More importantly, the waste of space in the kiosk storage volume represents time and inconvenience in having to restock the rack more frequently than if efficient or optimized use of the available cabinet storage volume is achieved. In practice, a convenient way to configure a rack for efficient storage is effected using a selection algorithm that is run by a processing module located at the kiosk or at a remote location to effect virtual stocking of the rack using available modules and to optimize rack storage efficiency by appropriate selection of rack modules.

Data inputs for one such selection algorithm for use with the illustrated rack include (a) rack modules available from a set of rack modules, the members of the set being different from one another, such as the modules 46, 48, 50, (b) the size distribution (i.e. bin sizes and number of bins of each size) represented by each of the rack modules of the set, (c) the medication list(s) or other target inventory(s) of items, (d) item characteristics of the target medication lists or inventory, such characteristics including, for example, any or all of quantities of each size of item, item dimensions, item shape, item volume, and item type, and (e) one or more stocking rules for determining what items in terms of the characteristics listed in (d) can be stocked in what size of bin.

One typical stocking rule might require that any item must go in the smallest bin that can accommodate the item size with specific width and height excess of bin size over item size. In this respect, for drug items in a dispensary kiosk of the type described, a suitable excess bin width is at least 4 mm. and a suitable excess bin height tolerance is at least 10 mm. It has been found that while very efficient stocking can be achieved where the item width matches the accommodating bin size even more closely, such close matching comes at the expense of an increased frequency of problems in the pick process. Consequently, depending on the desired kiosk operating performance, the selection algorithm typically embodies a compromise position for achieving relatively high stocking efficiency but not at the expense of unacceptably high pick problems.

An alternative stocking rule might specify that items of a certain size may be stored in either of two specified bin sizes, the two bin sizes having different widths. Clearly, in such a situation, an item of a specific size may be more efficiently stored in a bin of the first size than a bin of the second size. But in optimizing the selection of a combination of rack modules such as modules 46, 48, 50 to accommodate a particular medication list, being able to place a particular item in a bin having a width not ideally suited to that item may actually enable the overall stocking efficiency for that target inventory to be increased. Once again, some loss of pick efficiency may need to be factored into the stocking efficiency algorithm because, if the width of a item is very small compared with the width of a bin for storing that item, then periodically the pick head may simply fail to engage with and pick the item. In practice, for drug items in a dispensary kiosk of the type described, a suitable excess of the bin width over the item width is not greater than the bin width/2+4 mm. As indicated previously, a bin may accommodate a single item or a depth-wise row of items as shown in FIG. 9. The items may have a large or a small depth which may mean that more small items than large items can be accommodated in a bin. A further exemplary stacking rule requires that item depth is considered in depth-wise filling the bins to the maximum possible extent. Other rules may be established that determine a permitted mix of items permitted within a particular bin, whether as to item type, shape or other characteristic.

One suitable metric for measuring stocking efficiency is the cumulative excess of bin size over item size for all of the bins of the rack when populated by the target inventory. Such excess can be cumulative width, cumulative height, or a combination of cumulative width and height. Another possible exemplary metric is the maximum number of the target inventory that can be accommodated in the rack module combinations (if less than the target inventory can be accommodated) or the maximum number of items over the target inventory that can be accommodated (if more than the target inventory can be accommodated).

Any of a number of secondary factors can be factored into the measurement metric such as the stocking flexibility. In an inflexible stocking arrangement, any small change from the target inventory may require a corresponding change in the combination of rack modules whereas in a more flexible stocking arrangement, a small change in the target inventory would not demand that one or more of the rack modules in the rack must be exchanged to accommodate the change.

A further exemplary secondary factor that can be factored into the efficiency metric is a tolerance for inventory fragmentation. As previously indicated, the pick head 18 can only pick the foremost item in a depthwise (or front-to-back) row as shown in FIG. 9. In practice an item may be located towards the back of such a row. If that item is selected, it means that unselected items in front of it must be picked and parked so that the pick head can access the selected item. Each of the pick and park operations adds delay to the dispensing operation. The capacity for a particular rack module combination to reduce or minimize the incidence of pick and park delays is a further secondary factor of value in assessing the operational efficiency of rack module combinations. It will be appreciated also that reduction of required pick and park operations can also be factored into a further stocking role.

A further exemplary secondary factor that can be factored into the efficiency metric is a tolerance for anomalous sales activity. A typical target inventory might include a large number of a frequently prescribed small drug item and a small number of an infrequently prescribed small drug item. Typically, the target inventory is constructed to match the expected frequency of prescription and, ideally, the inventory is supplied to dispensary users at a rate that matches the frequency of prescription. However, there may be anomalous sales activity such as a run on sales of one of the drugs. The tolerance for anomalous sales activity is a measure of how tolerant a particular rack module combination would be to such activity without requiring frequent service calls to restock the target inventory.

In operation, the efficiency determination algorithm may be run to cycle through all possible arrangements of rack modules drawn from the rack module set and to score the stocking efficiency of each arrangement according to some assigned metric. The scores for the different combinations of rack module are then compared to find the highest stocking efficiency as governed by the stocking rules.

As an alternative to cycling completely through every available combination of rack modules drawn from the set of available modules, a different algorithm may adopt an iterative process in which, initially, only part of an analysis of a particular rack combination is performed according to a particular analyzing sequence to obtain a projected stocking efficiency. The interim results may then be used to discard combinations of rack modules that are clearly mismatched to the target medication list or inventory with remaining combinations then being subject to a fuller analysis. In a further alternative, the target inventory is preliminarily analyzed to determine the total number of items of one or more sizes: for example, the total number of small items. Subsequently, efficiency determinations are made only of combinations of rack modules that can accommodate that number of small items

Clearly, a variety of algorithms for determining rack module selection can be designed and there is no intention to limit the selection criteria or the inputs in computing a satisfactory selection of modules. For example, a further input could set a range of possible medication lists or target inventories instead of a single medication list with a heuristic for ensuring that a predetermined efficiency metric is achieved overall for the lists. Clearly, in such an instance, the stocking efficiency for a particular medication list may be less than for the previously described embodiment. But for the range of medication lists, the stocking efficiency will be greater in the sense of accommodating a greater variety in the items to be stocked.

In operation of the kiosk dispensary, the rack is used to store medicament items either with a single item in a bin or with some or all of the bins containing a vertical stock and/or a horizontal row of items which are, in use, selectively manipulated to obtain access to a desired item. In a typical application, the items are pill boxes or pill bottles, but may also be bottles containing liquid medicament or may be different items entirely. In the row embodiment, the number of items in each row is limited only by the depth of the bin.

As indicated, the bins have a range of heights and widths in order to accommodate a corresponding variety of sizes of medicament item. In the illustrated embodiment, each of the modules 46, 48 and 50 have common widths but a range of heights. In other embodiments, in a particular module, the heights are common and at least some of the bins have widths different from the widths of other bins in the module.

As previously indicated, a particular combination of differently configured rack modules is selected that meets defined metrics for assessing stocking efficiency. These metrics may comprise primary metrics related to the efficient use of space throughout the storage vault 14 and may also include secondary metrics such as the previously described tolerance for fragmentation. Also of relevance to the efficient use of vault storage space are the selection of bin widths and heights. Thus, the distribution of bin sizes (width and height) throughout a fully assembled rack depends on both the particular selection of a rack module combination and the sizes of bins in the modules of that particular combination.

In the illustrated embodiment, as previously described, the bins have three widths: 105 mm. for the bins of rack module 46, 82.5 mm. for the bins of rack module 48, and 50 mm. for the bins of rack module 50. The bin widths are chosen based on the range of widths of packages in the target inventory and based also on an integer multiple of each bin width closely matching the overall width of the rack modules.

The target inventory may have items that together occupy a wide range of widths, but the target inventory is notionally divided into just three sizes—large, medium and small. In the illustrated embodiment, large width items are those having widths from 56 to 101 mm., medium width items are those having widths from 45 to 78 mm., and small items are those having widths from 29 to 46 mm. It will be seen that the width ranges for the target inventory items overlap. In the illustrated embodiment, one of the stocking rules is that items of the target inventory are notionally considered for storage in either of two widths of bin. In terms of computing stocking efficiency, there is an initial determination to identify which items can be placed into only one bin width and which items can be placed into either of two bin widths. In the subsequent efficiency analysis, the efficiency algorithm is run with the “dual bin” prospects being notionally fitted into both widths of bin. Clearly, a different range of item widths, such as, for example a 4-category range of small, lower-medium, upper-medium and large can be chosen, with a matching disposition of bin widths in the rack modules. It will be appreciated also that the target inventory can be similarly, or alternatively, graded in terms of height with a view to a target inventory of items being of a size to allow at least some of them to be fitted into two bin height categories.

In the illustrated embodiment, however, a simpler assignment of bin height dimensions is made in the course of designing the set of rack modules. Based on a “super” inventory, an estimate is made, for each of the small, medium and large width items, of the range of item heights. The item heights are split into four categories with four corresponding bin heights being assigned, and with a bin of a certain height being intended to accommodate any item up to 10 mm less in height than the bin.

In the illustrated embodiment, the set from which storage rack modules can be drawn numbers three. The set can consist of fewer (i.e. two) or more rack modules. Clearly a greater number of bin size distributions are enabled with a larger rack module set and the expanded bin size distributions enable, in turn, finer matching of storage capacity to a medication list or other target inventory of items. The fine matching enabled by having a large variety of modules in the available set must be offset against more complex manufacturing demands.

Although in the preferred embodiment described herein, the bins are located in a row-column array, other arrays are possible such as a radial array or a diagonal array. In addition, although as shown in the illustrated embodiments of the invention, interengaging brackets and slots are used to fix the rack modules to the cabinet wall for ease of demounting, alternative fixture means can be used. For example, the back wall and the rack modules can be formed with respective cooperating I and U rails. In use the U rails are slid onto or placed over the I rails and locked into place.

In the illustrated embodiment, the rack modules are of a common size in their full vertical and horizontal extents. This is particularly useful to enable the modules to be easily swapped in and out when adjustments to a kiosk stocking capacity must be effected to accommodate a different medication list or for some other reason. It will be appreciated that another layer of modularity can be implemented by having rack modules which are, for example, of double width or double height, etc. When configuring the rack for efficient storage, the algorithm can then accommodate both advantages and the disadvantages inherent in having modules that may not have module height or width identical to all other modules.

Although an embodiment of the invention has been described in the context of dispensing drugs upon presentation of a script, the invention is applicable generally to a kiosk for dispensing items where there may be variation in the size of items to be stocked in the kiosk and where the distribution of sizes in a target inventory may differ from kiosk to kiosk or may differ over time owing to alteration in consumer demand, or to changes in the nature of products available for dispensing, etc.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A method of configuring storage in a dispensing kiosk using one or more rack modules of at least some of a set of rack modules, the rack modules each having an array of bins having a range of bin sizes and a range of quantities of bins of each size thereby to present a predetermined bin size distribution, the predetermined bin size distribution of one rack module of the set differing from the predetermined bin size distribution of the other rack modules of the set, the rack modules adapted to be mounted on a kiosk support structure to form a rack, the method comprising taking a target inventory of items for stocking the dispensing kiosk with items, the items of the target inventory having a range of item sizes and a range of quantities of each item size, determining a plurality of combinations of the rack modules as candidates for mounting on the kiosk support structure to form the rack, selecting that combination of the rack modules from the plurality of combinations of the set of rack modules that maximizes efficiency of stocking of the target inventory in the rack if the stocking is effected pursuant to at least one stocking rule, and mounting the selected combination of rack modules on the kiosk support structure.

2. The method of claim 1, the bin size and the item size comprising at least one of height, width and depth.

3. The method of claim 1, the arrays being row column arrays.

4. The method of claim 3, at least one of the rack modules having vertical walls extending over the full vertical extent of the rack module.

5. The method of claim 3, at least one of the rack modules having horizontal walls extending over the full horizontal extent of the rack module.

6. The method of claim 1, wherein said at least one stocking rule comprises each of the items of a certain size being stockable in only one size of bin.

7. The method of claim 1, wherein said at least one stocking rule comprises each of the items of a certain size being stockable in a plurality of sizes of bin.

8. The method of claim 1, in which the at least one stocking rule requires that the stocking of each item into a corresponding bin leaves an excess of the bin size over the item size which is greater than a predetermined minimum.

9. The method of claim 1 in which the at least one stocking rule requires that the stocking of each item into a corresponding bin leaves an excess of the bin size over the item size which is less than a predetermined maximum.

10. The method of claim 1, the rack modules demountably mountable to a back wall of the kiosk support structure.

11. The method of claim 10, the rack modules mountable by means of brackets on the modules engaging slots in the back wall.

12. The method of claim 1, wherein the stocking efficiency is based on the minimum cumulative excess of bin sizes over item sizes for the combinations of rack modules.

13. The method of claim 1, wherein the stocking efficiency is based on the maximum number of items of a target inventory that can be accommodated in the combinations of rack modules.

14. The method of claim 1, wherein a measure of the stocking efficiency factors in stocking flexibility.

15. The method of claim 1, wherein a measure of the stocking efficiency factors in inventory fragmentation.

16. The method of claim 1, further comprising determining the stocking efficiencies obtained by notionally fully stocking the target inventory in the respective rack module combinations, comparing the determined efficiencies, and selecting the combination with the highest efficiency.

17. The method of claim 1, further comprising determining an interim efficiency measured at an interim stage of notionally stocking one of the rack module combinations and discarding said one combination from candidacy if the interim efficiency is below a threshold.

18. An assembly of rack modules mounted on a kiosk support structure to form a rack, the assembly of rack modules comprising one or more rack modules of at least some of a set of rack modules, the rack modules of the set each having an array of bins having a range of bin sizes and a range of quantities of bins of each size thereby to present a predetermined bin size distribution, the predetermined bin size distribution of one rack module of the set differing from the predetermined bin size distribution of the other rack modules of the set, the assembly selected in relation to a target inventory of items for stocking the kiosk with items, the items of the target inventory having a range of item sizes and a range of quantities of each item size, the selection made from a plurality of combinations of the rack modules determined to be candidates for mounting on the kiosk support structure to form the rack, the selection being that combination of the rack modules that maximizes efficiency of stocking of the target inventory in the rack if the stocking is effected pursuant to at least one stocking rule.

19. The assembly of claim 18, the bin size and the item size comprising at least one of height, width and depth.

20. The assembly of claim 18, the arrays being row column arrays.

21. The assembly of claim 18, at least one of the rack modules having vertical walls extending over the full vertical extent of the rack module.

22. The assembly of claim 18, at least one of the rack modules having horizontal walls extending over the full horizontal extent of the rack module.

23. The assembly of claim 18, the at least one stocking rule comprising each of the items of a certain size being stockable in only one size of bin.

24. The assembly of claim 18, the at least one stocking rule comprising each of the items of a certain size being stockable in multiple sizes of bin.

25. The assembly of claim 18, in which the at least one stocking rule requires that the stocking of each item into a corresponding bin leaves an excess of the bin size over the item size that is greater than a predetermined minimum.

26. The assembly of claim 18, in which the at least one stocking rule requires that the stocking of each item into a corresponding bin leaves an excess of the bin size over the item size that is less than a predetermined maximum.

27. The assembly of claim 18, the rack modules demountably mountable to a back wall of the kiosk support structure.

28. The assembly of claim 27 the rack modules mounted by means of brackets on the modules engaging slots in the back wall.

29. The apparatus of claim 18, the stocking efficiency having been determined based on the minimum cumulative excess of bin sizes over item sizes for the combinations of rack modules.

30. The apparatus of claim 18, the stocking efficiency having been determined based on the maximum number of items of a target inventory that can be accommodated in the combinations of rack modules.

31. The apparatus of claim 18, the stocking efficiency having been determined based on stocking flexibility.

32. The apparatus of claim 18, the stocking efficiency having been determined based on inventory fragmentation.

33. The assembly of claim 18, the stocking efficiencies having been determined by notionally fully stocking the target inventory in the respective rack module combinations, comparing the determined efficiencies, and selecting the combination with the highest efficiency.

34. The assembly of claim 18, an interim efficiency of the rack module combinations having been determined at an interim stage in the notional stocking, at least one rack module combination having been discarded from candidacy owing to the interim efficiency being below a threshold.
